(19) United States
(12) Patent Application Publication
(10) Pub. No.: US 2011/0214156 A1
(43) Pub. Date: Sep. 1, 2011

(54) SYSTEMS AND METHODS FOR PROVIDING FAST VIDEO CHANNEL SWITCHING

(76) Inventors: Eric Desmicht, Thorigne Fouillard (FR); Pierre R. B. Le Pifre, Hermanville SUR MER (FR)

(21) Appl. No.: 13/062,898

(22) PCT Filed: Aug. 11, 2009
(86) PCT No.: PCT/IB2009/053536

§ 371 Date: May 6, 2011

(30) Foreign Application Priority Data
Sep. 15, 2008 (EP) 08290863.3

(51) Int. Cl. H04N 7/16

(52) U.S. Cl. 725/151

(57) ABSTRACT

A video decoding device receives video images encoded as video signal data for a selected one of multiple channels, for example provided by a cable TV or satellite TV service. Responsive to a request to switch from viewing a previously-selected channel to viewing a newly-selected channel, the video decoding device enters a first mode for displaying a preview representation of the video signal data received for the newly-selected channel. In this preview mode, video signal data for the newly-selected channel is received and stored, and a first available image from the video signal data is decoded and provided for display as a preview representation. The preview mode image is replaced by a real time representation of the video signal data once it is determined that the stored video signal data exceeds a threshold amount, for example an amount to compensate for maximum expected jitter.

### PRIORITY INFORMATION

This patent application claims priority from PCT patent application PCT/IB2009/053536 filed Aug. 11, 2009, which claims priority to EP patent application 08290863.3 filed Sep. 15, 2008, both of which are hereby incorporated by reference.

### FIELD OF THE INVENTION

This patent document relates to selecting a video source from among multiple channels, receiving the selected encoded video signals, and decoding the video signals for display, and more particularly to reducing the perceived switching delay when selecting a new channel.

### BACKGROUND OF THE INVENTION

Digital video transmission is fast replacing analog transmission for providing television programming, with set-top boxes (STBs) used to make the adaptation between the antenna and the display. Criteria often used by customers to evaluate the performance of STBs include displaying the incoming video program without perceptible degradations such as video freeze, video blocks, and the like, as well as little or no perceptible delay between selecting a new channel and the new program being displayed. Such delay is known as “zapping time,” and can be on the order of one second for a typical STB. Customers perceive such delays unfavorably, particularly when compared to the nearly instantaneous switching of analog broadcast channels.

Digital video has traditionally been transmitted via satellite or cable, and more recently via internet-based transmission, for example using an asymmetric digital subscriber line (ADSL). Each of these can present issues related to delay, data corruption, and transmission time variations, which can lead to frame freezing, blocking, and jitter. For example, one of the characteristics of video originating from the internet is packet loss. The route between the transmitter and the receiver is generally not fixed and can change on the fly. Congestion along the route can cause the network to discard some data packets, and it is up to the requester to re-ask for transmission of the lost packets. Such operations create variations in the transmission delay.

In the case of ADSL, packets are not lost in the same manner, but errors may be introduced. It is possible to attempt to correct the errors, taking advantage of the bi-directional nature of the unicast communication between telephone central and the end-user. For example, when the receiver detects errors in a packet, it can re-ask for the packet, which in turn can lead to variations in the transmission delay of some packets compared to other packets.

In each of these examples, the transmission delay is not constant from packet to packet. Due to this variability, even though the first packets may be received relatively quickly, the overall transmission delay increases as more and more packets are received. When displaying a real time representation of the video signal, such increased delay may lead to an emptying of the incoming video buffer, resulting in video freeze while the decoder waits for new packets. Efforts to reduce such video freeze include waiting to decode any of the video signals until sufficient data is stored. The amount of data deemed sufficient is determined based on the maximum expected transmission delay, thus avoiding any instance of emptying the incoming video buffer.

However, each time the viewer switches from viewing one program to viewing another, there is a waiting period prior to video viewability during which the incoming video buffer is being sufficiently filled prior to starting the decoding. As such, there has been a trade-off between avoiding video freeze and video blocks on the one hand, and allowing fast channel changing on the other hand.

### SUMMARY OF THE INVENTION

The present invention is directed to overcoming the above-mentioned challenges and others related to the types of applications discussed above and in other applications. These and other aspects of the present invention are exemplified in a number of illustrated implementations and applications, some of which are shown in the Figures and characterized in the claims section that follows.

According to an example embodiment, the present invention provides a method for use with a video decoding device that receives video images encoded as video signal data for a selected one of multiple channels. Such method includes receiving a request to switch from a previously-selected channel to a newly-selected channel, and in response thereto, entering a first mode for displaying a preview representation of the video signal data. In the first, preview mode video signal data for the newly-selected channel is received and stored, and a first available image from the video signal data is decoded and provided for display as a preview representation. In response to determining that the stored video signal data exceeds a threshold amount, such method enters a second mode in which the preview representation of the video signal data is replaced with a real time representation of the video signal data. In certain embodiments, the first available image may be updated, corrected, or replaced based on additionally received information and/or a determination that the first available image is corrupted or includes errors.

According to another example embodiment of the present invention, the present invention provides a video decoding device that includes a receiver, a processor arrangement, and a display control output. The receiver receives video signal data on a selected one of multiple channels. The processor arrangement is operable in a first mode for displaying a preview representation of the video signal data and in a second mode for replacing the preview representation of the video signal data with a real time representation of the video signal data. The first mode is initiated in response to a request to switch to a newly-selected channel, and includes receiving video signal data for the newly-selected channel, storing the video signal data received for the newly-selected channel, and decoding and providing for display a first available image from the video signal data received for the newly-selected channel. The second mode is initiated in response to determining that the stored video signal data exceeds a threshold amount, and includes replacing the preview representation of the video signal data with a real time representation of the video signal data. The display control unit provides a display output that corresponds to the preview representation of the video signal data in the first mode and to the real time representation of the video signal data in the second mode.

The above summary is not intended to describe each illustrated embodiment or every implementation of the present invention.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates a block diagram of a video decoding device in accordance with certain embodiments of the present invention;

FIG. 2 schematically illustrates an implementation of a video decoding device in accordance with certain embodiments of the present invention; and

FIG. 3 shows a flow chart of steps that may be performed in accordance with an example embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention, including that defined by the claims.

### DETAILED DESCRIPTION OF THE INVENTION

The present invention is applicable to a variety of applications in which a video source is selectable from multiple video source channels for decoding and viewing, and is particularly applicable to video decoder devices such as set top boxes (STBs). While the present invention is not necessarily limited to such applications, an appreciation of various aspects of the invention is best gained through a discussion of examples in such an environment.

According to an example embodiment of the present invention, a video decoding device, such as an STB, receives video images encoded as video signal data for a selected one of multiple channels. When a viewer switches to a newly-selected channel, the video decoding device enters a first mode for displaying a preview representation of the video signal data received on the newly-selected channel. In this preview mode, video signal data for the newly-selected channel is received and stored, and a first available image from the video signal data is decoded and provided for display as a preview representation. Displaying the first available image allows the viewer to perceive a reduced delay between channel switching and new channel viewing as compared to waiting for certain data packets to be received or a certain amount of video data to be buffered prior to display. The preview mode image is replaced by a real time representation of the video signal data once it is determined that the stored video signal data exceeds a threshold amount, for example an amount to compensate for maximum expected jitter.

In certain embodiments, the present invention may be used to improve a viewer's perception of the zapping time when switching between channels, for example in the case of video provided from a jittered network. In example implementations of the present invention, the perceived zapping time may be cut in half compared to typical STBs, for example the perceived zapping time may be reduced by about 200 msec.

Without being bound by any theory of human perception, when a viewer switches from viewing one video source to viewing another, the very first image(s) seen are not analyzed in full detail. Instead, the viewer first gains his or her bearings by sorting out the context present in the images, for example by generally recognizing locations, persons, or objects. After the context is understood, the movements and actions may be followed. As such, when the viewer switches between channels, any delay in presenting an image from the newly-selected video source is readily perceived. However, the delay between presenting a static image as a preview representation of the video signal and presenting a real-time representation of the video signal may not be noticed by the viewer if the delay is on the order of the time it takes for the viewer to transition from context perception to movement perception.

As such, in certain embodiments, the present invention includes a processor arrangement that, upon starting to receive video signal data for a newly-selected channel, decodes a first available image so that it can be displayed as a preview representation as soon as possible and within a window of time acceptable to the viewer. With this first picture, the viewer can perceive the context of the program. As this preview representation continues to be displayed, a video data input buffer stores the video data being received. When the stored video data is of an amount sufficient to compensate for possible jitter (for example, an amount sufficient so that little or no video freezing occurs during real-time playback), the preview representation can be replaced by the real-time representation. In many cases, the time needed to compensate for maximum jitter is in the range of about 200 msec.

In an example implementation, upon switching to a newly-selected channel, the decoding process for the received video signals proceeds in a first mode for displaying a preview representation of the video signals and in preparation for displaying a real-time representation when sufficient signals have been stored. The preview mode begins in a so-called “buffer control” or “as soon as possible” phase in which the first available image is decoded and provided for display. As such, as soon as the video data are received, the video decoder decodes them for producing the first available image. When the first available image has been decoded, the decoder operates in a “synchronization locked” phase in which the first available image continues to be displayed until there is sufficient data in the incoming buffer to allow the video to be displayed in real-time without video freeze or video block.

In circumstances where the first available image includes corrupted data, or where receiving additional video signal data allows the first available image to be more completely decoded, the additional information may be used to update the display of the first available image or even to replace the first available image with a next available image while still in the preview mode. For example, if errors are present in the first received packets, the decoder can still decide to decode the packets even though some macro-blocks or missing data may be visible in the display of the first available image. As additional information is received, for example based on a request to re-send data due to the detected errors, the first available image may be re-decoded and provided for display, thereby correcting the errors. In this way, a preview image can still be provided as soon as possible with little or no perceptible disruption for the viewer. In another example, an image that relies upon other images to decode (for example, a P slice-image or a B slice-image for MPEG-2 encoded video) is decoded even where these other images are not received. The image can be updated if, for example, the other images are received and/or a subsequent image (for example, an I slice-image for MPEG-2 encoded video) is received.

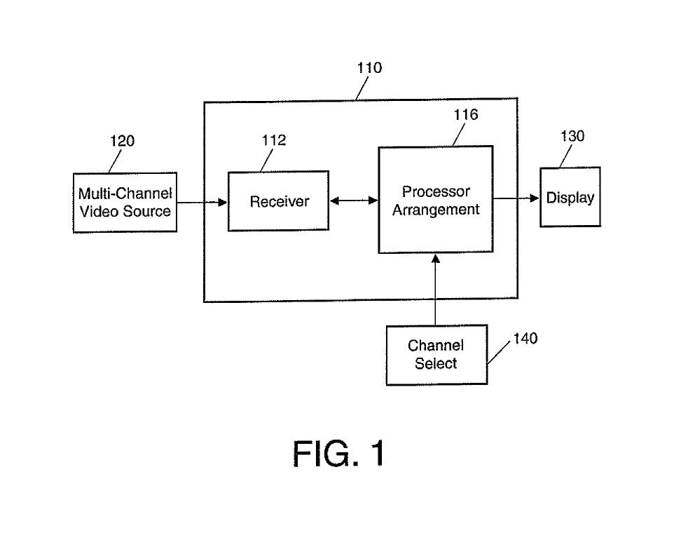

FIG. 1 schematically illustrates the use of a video decoding device 110, such as an STB, in accordance with certain embodiments of the present invention. The video decoding device 110 is configured to receive video images encoded as video signal data for at least a selected one of multiple channels, illustrated by multi-channel video source 120. For example, the multi-channel video source may include cable TV, satellite TV, the interne (including as provided via cable and/or satellite), a local or private network, and so forth.

For the sake of simplicity, the functions of the video decoding device 110 will be described in terms of selecting and receiving video signal data on a single channel, although it will be understood that signals may be received and stored simultaneously from multiple channels even though one of the channels is being decoded and provided for primary viewing in real time. Moreover, it will be recognized that any of the functions of the video decoding device 110 may be suitably performed using software, hardware, programmable logic, discrete logic, and combinations thereof.

The video decoding device 110 includes a receiver 112 that receives the video signals so that the video signals may be provided to a processor arrangement 116 for demultiplexing, storing, decoding, and otherwise processing and providing an output signal suitable for displaying on a display device 130. The processor arrangement 116 is also configured to receive channel selection requests 140, for example from an infrared remote control device operated by a viewer. The processor arrangement 116 uses the channel selection request 140 to control or otherwise tune the receiver 112 to receive video signals on the selected channel. In other circumstances, the receiver 112 is a transceiver that relays the channel selection request to a network supplying the multi-channel video source 120. The processor arrangement 116 may include functions such as demultiplexing, decoding, FIFO buffering, processing, user-request control, and display control. Each of these functions may be suitably implemented in hardware, software, or a combination of both.

The processor arrangement 116 is configured to function in a preview mode upon switching to a newly-selected channel. In the preview mode, the processor arrangement decodes and provides for display a first available image from received video signal data for the newly-selected channel. As video signal data is received for a newly-selected channel, the video decoding device 110 stores the data, for example in a FIFO buffer. When the amount of data stored in the buffer reaches a threshold amount, the processor arrangement enters a real-time mode in which the video signal data is decoded and provided for display as a real-time representation of the video images. The decoding and display of video images can be performed in any suitable manner, for example as described in International Publication WO 2005/060244 and in European Patent Application EP 1 631 076, which documents are incorporated by reference.

To facilitate determining whether the amount of newly-received video signal data has reached a threshold amount, the video signal data may be received and stored into an emptied buffer. The video decoding device 110 may include multiple buffers so that video signal data on one or more previously selected channels (for example, previously viewed, selected for recording, and so forth) can continue to be received and stored when receiving, decoding and displaying video on a newly-selected channel. In some implementations, the buffer receiving video signals on the currently-viewed channel is emptied in response to the video decoding device 110 receiving a channel switch request, and the same buffer is then used to store incoming video signal data on the newly-selected channel.

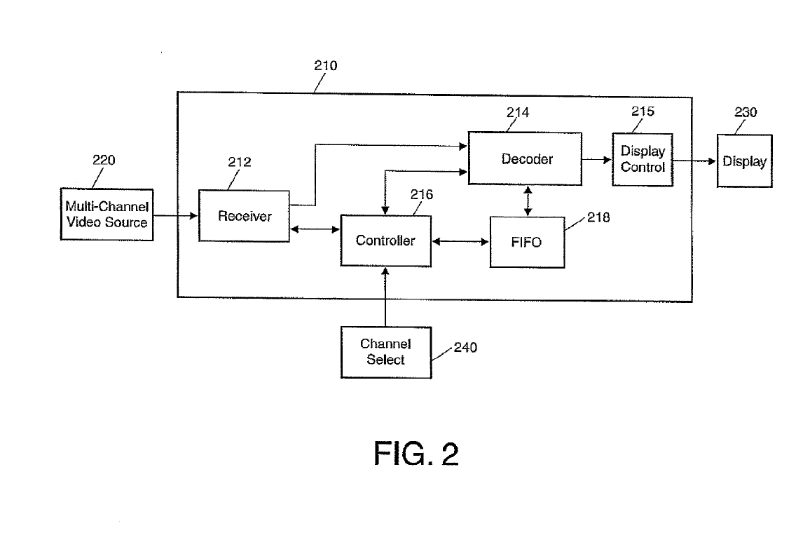

FIG. 2 schematically illustrates an example implementation of a video decoding device 210 that receives encoded video signals from multi-channel video source 220, that provides output signals representative of the received video and suitable for display 230, and that receives channel selection requests 240, for example from a viewer. In response to receiving a channel selection request 240, a controller unit 216 tunes the receiver 212 to receive video signal data on the selected channel. In embodiments such as ADSL where the receiver is also configured to transmit information back to the provider, the receiver may relay channel select request information to the video source provider so that the selected video source signal is provided. Upon receiving the first data packets for the newly-selected channel, the decoder 214 decodes a first available image, which is provided to display control 215 for output as a preview representation on display 230. At the same time, the received video signal data is stored to an input buffer such as FIFO 218. When the fullness of FIFO 218 has reached a threshold amount (for example, to compensate for maximum jitter), the decoder 214 switches to a real time representation mode in which data stored in FIFO 218 is decoded and provided to display control 215 for output as a real time representation on display 230. The controller 216 may include logic that controls whether the decoder 214 is functioning in a preview mode or in a real time mode in response to a channel select request and a buffer fullness status. It will be recognized that any of the functions of the video decoding device 210, including that of the receiver 212, decoder 214, display control 215, controller 216, and FIFO 218 may be suitably performed using software, hardware, programmable logic, discrete logic, and combinations thereof, and further that the separate functional blocks are shown for illustrative purposes and may be combined or further sub-divided in any suitable manner.

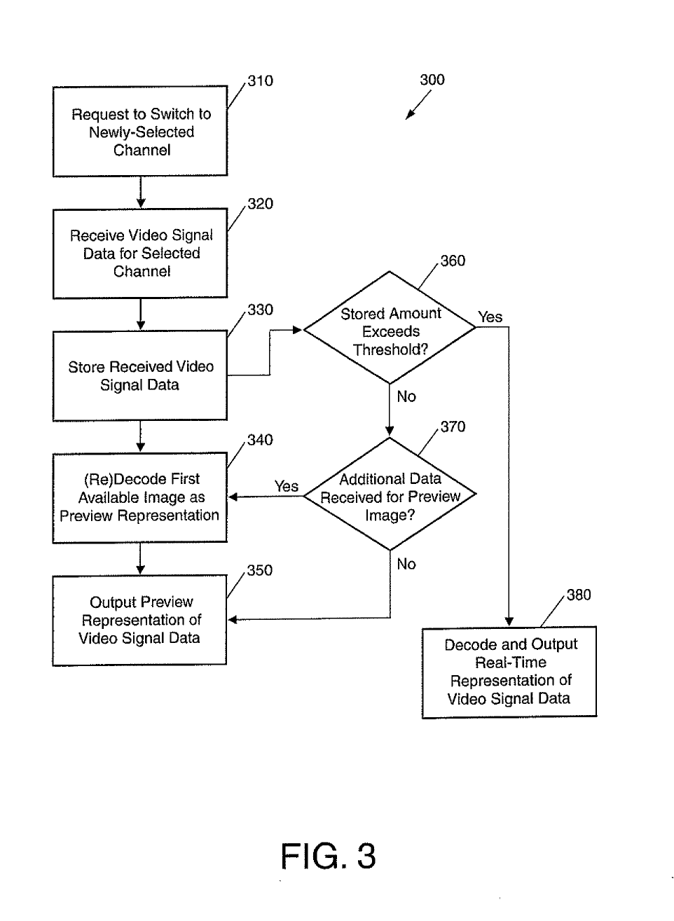

FIG. 3 shows a flow diagram 300 illustrating steps that may be performed in accordance with certain embodiments. For example, in response to receiving a request to switch to a newly-selected channel 310, video signal data is received for the selected channel 320. The received video signal data is stored 330 and a first available image is decoded as a preview representation 340. The preview image is output for display on a display device 350. As video signal data continues to be received 320 and stored 330, it is determined whether the amount of stored video signal data exceeds a threshold amount 360. If the amount of stored video signal data does not yet exceed the threshold amount, the preview representation continues to be provided for display 350. When the amount of stored video signal data exceeds the threshold amount, the video signal data is decoded and provided for output as real-time video 380.

In certain embodiments, the preview representation may be updated, corrected, or replaced based on additional information in the received and stored video signal data. When the amount of stored video signal data does not yet exceed the threshold amount, a determination can be made whether additionally received video signal data includes information that may be used to update the preview image 370. For example, when the first available image is a B slice-image, full decoding of the image may require information encoded into subsequently-received image data. As such additional information is received it may be used to re-decode the first available image so that an updated preview representation may be provided for display 340. Re-decoding of the first available image also includes discarding a first available image that was decoded from corrupted data and replacing it with a next available image that is decoded and provided for display as the preview representation. Such next available image is provided for display until it is replaced by the real time representation, and may be updated in the same manner as the first available image.

In addition to the above, the various processing approaches described herein can be implemented using a variety of devices and methods including general purpose processors implementing specialized software, digital signal processors, programmable logic arrays, discrete logic components and fully-programmable and semi-programmable circuits such as PLAs (programmable logic arrays). For example, the above algorithms are executed on a microcomputer (a.k.a. microprocessor) in connection with certain embodiments, and as may be implemented as part of one or more of the devices shown in the Figures.

The various embodiments described above and shown in the Figures are provided by way of illustration only and should not be construed to limit the invention. Based on the above discussion and illustrations, it will be recognized that the circuits described herein may be manufactured using standard processes and techniques. Those skilled in the art will readily recognize that various modifications and changes may be made to the present invention without strictly following the exemplary embodiments and applications illustrated and described herein. Such modifications and changes do not depart from the true scope of the present invention.

What is claimed is:

1. A method for use with a video decoding device that receives video images encoded as video signal data for a selected one of multiple channels, the method comprising:
in response to a request to switch from a previously-selected channel to a newly-selected channel, entering a first mode for displaying a preview representation of the video signal data, the first mode including
receiving video signal data for the newly-selected channel;
storing the video signal data received for the newly-selected channel; and
decoding and providing for display a first available image from the video signal data received for the newly-selected channel; and
in response to determining that the stored video signal data exceeds a threshold amount, entering a second mode for replacing the preview representation of the video signal data with a real time representation of the video signal data.

2. The method of claim 1, wherein the first mode further comprises the step of re-decoding the first available image in response to receiving additional video signal data, and providing the re-decoded first available image for display.

3. The method of claim 2, wherein the additional video signal data comprises data packets correcting for errors in the first available image.

4. The method of claim 3, wherein the video signal data comprises is MPEG-2 encoded video and the first available image comprises a B slice-image or a P slice-image.

5. The method of claim 2, wherein the additional video signal data is received in response to the video decoding device detecting errors in the first available image and generating a request to re-send video signal data corresponding to the first available image.

6. The method of claim 1, wherein the first mode further comprises the step of decoding a next available image responsive to determining that the first available image includes corrupted data, and providing the next available image for display.

7. The method of claim 6, wherein the video signal data comprises MPEG-2 encoded video and the next available image comprises an I slice-image.

8. The method of claim 1, wherein the threshold is selected to provide a sufficient amount of stored video signal data to allow the real time representation of the video signal data to be displayed without interruption.

9. The method of claim 1, wherein the threshold is selected to compensate for maximum jitter during the real time representation of the video signal data.

10. A video decoding device comprising:
a receiver that receives video signal data on a selected one of multiple channels;
a processor configured to receive a request to switch from a previously-selected channel to a newly-selected channel, in response to the request, to enter a first mode for displaying a preview representation of the video signal data, the first mode including receiving video signal data for the newly-selected channel, storing the video signal data received for the newly-selected channel, and decoding and providing for display a first available image from the video signal data received for the newly-selected channel, and in response to determining that the stored video signal data exceeds a threshold amount, to enter a second mode for replacing the preview representation of the video signal data with a real time representation of the video signal data; and
a display control output providing the preview representation of the video signal data in the first mode and the real time representation of the video signal data in the second mode.

11. The video decoding device of claim 10, wherein the processor comprises a decoder that decodes the received video signal data for display and a first-in first-out (FIFO) buffer that stores the received video signal data.

12. The video decoding device of claim 11, wherein the processor comprises a controller to receive the request and to signal the receiver to begin receiving video signal data on the newly-selected channel.

13. The video decoding device of claim 12, wherein the controller signals the decoder to operate in the first mode in response to the request and to operate in the second mode in response to the video signal data stored in the FIFO exceeding the threshold amount.

14. The video decoding device of claim 10, wherein the processor operating in the first mode is further configured to re-decode the first available image in response to receiving additional video signal data applicable to the first available image.

15. The video decoding device of claim 10, wherein the processor is further configured to detect errors in the received video signal data and, responsive thereto, to generate a request to re-send video signal data.

16. The video decoding device of claim 15, wherein the receiver is a transceiver configured to transmit the request to re-send video signal data.
